(19) United States
(12) Patent Application Publication
(10) Pub. No.: US 2017/0347388 A1
(43) Pub. Date: Nov. 30, 2017

(54) Transparently Connecting Mobile Devices to Multiple Wireless Local Area Networks

(71) Applicant: Wandering WiFi LLC, Atlanta, GA (US)

(72) Inventors: Dawei Cai, Marietta, GA (US); Jyothiprakash Halebeed, Marietta, GA (US)

(21) Appl. No.: 15/606,072

(22) Filed: May 26, 2017

Related U.S. Application Data
(60) Provisional application No. 62/342,694, filed on May 27, 2016.

(51) Int. Cl. H04W 76/02; H04L 29/08; H04W 12/06; H04W 4/02; H04W 8/00; H04W 72/04; H04W 84/12; H04L 29/12

(52) U.S. Cl. CPC H04W 76/025; H04W 8/005; H04L 67/306; H04W 72/0493; H04W 12/06; H04W 4/023; H04L 61/6081; H04W 84/12

(57) ABSTRACT

A method can include determining that a mobile device is within a communication range of an access point for a first wireless local area network, causing the mobile device to present an interface that receives user input for at least one of authenticating the mobile device or authorizing the mobile device, and connecting the mobile device to the first wireless local area network based on the user input received via the interface. The method can further include determining that the mobile device is within a communication range of an access point for a second wireless local area network, determining a service set identifier for each access point is governed by a common access policy, and connecting the mobile device to the second wireless local area network based on the service set identifiers being governed by the common access policy.

### CROSS REFERENCE TO RELATED APPLICATIONS

This disclosure is related to and claims the benefit of priority of U.S. Provisional Application No. 62/342,694, titled “Transparently connecting mobile devices to multiple wireless local area networks” and filed on May 27, 2016, which is hereby incorporated by this reference in its entirety.

### TECHNICAL FIELD

This disclosure generally relates to computer-implemented methods and systems for connecting mobile devices to data networks and more particularly relates to seamlessly and transparently connecting mobile devices to multiple wireless local area networks.

### BACKGROUND

Mobile devices, such as smart phones and tablets, can connect to the Internet or other data networks via wireless local area networks. For example, to connect to a wireless local area network, a mobile device connects to one or more access points using WiFi or other suitable wireless protocols. The mobile device activates WiFi in response to user input and searches for at least one service set identifier (“SSID”), which identifies an access point within a communication range of the mobile device. For instance, the mobile device can present a list of SSIDs to a user and can receive user input selecting an SSID for a given WLAN.

Unless the user has access to directions for the free wireless access in a given location, assumptions must be made by the user as to which WLAN's are available for connection. For example, some “freely” accessible hotspots or other access points require additional registration information. Even if the user chooses a valid SSID and connects to the WLAN, the user may be redirected to a portal to accept certain terms and conditions before a connection is authorized. If the same mobile device later reconnects to the WLAN (e.g., at a later date), the user may need to repeat the process for accepting terms and conditions. Thus, current solutions may hinder a user from quickly connecting to a WLAN or, in the event of “fake” hotspots, establishing a safe connection to the Internet.

### SUMMARY

Aspects and examples are disclosed for seamlessly and transparently connecting mobile devices to multiple wireless local area networks. For example, a processing device can determine that a mobile device is within communication range of a first access point for a first wireless local area network. The processing device can cause the mobile device to present an interface that receives user input for authenticating the mobile device or authorizing the mobile device to connect to the first wireless local area network. The mobile device can be connected to the first wireless local area network based on the user input received via the interface. The processing device can determine, subsequent to the mobile device connecting to the first wireless local area network, that the mobile device is within communication range of a second access point for a second wireless local area network. A first service set identifier for the first access point and a second service set identifier for the second access point can be governed by a common access policy. The mobile device can be connected to the second wireless local area network based on the first service set identifier and the second service set identifier being governed by a common access policy.

This illustrative example is mentioned not to limit or define the invention, but to aid understanding thereof. Other aspects, advantages, and features of the present invention will become apparent after review of the entire description and figures, including the following sections: Brief Description of the Figures, Detailed Description, and Claims.

### BRIEF DESCRIPTION OF THE DRAWINGS

Aspects of the present disclosure can be better understood with reference to the following diagrams. The drawings are not necessarily to scale, with emphasis instead being placed upon clearly illustrating certain features of the disclosure.

FIG. 1 depicts an example of a mobile device receiving service set identifier (“SSID”) data that is used for transparently connecting the mobile device to multiple wireless local area networks according to one aspect of the present disclosure.

FIG. 2 depicts an example of the mobile device of FIG. 1 using the received SSID data for transparently connecting to an access point of a wireless local area network according to one aspect of the present disclosure.

FIG. 3 depicts an example of a process for transparently connecting a mobile device to multiple wireless local area networks according to one aspect of the present disclosure.

FIG. 4 depicts an example of a process for determining that a service set identifier for each access point is governed by a common access policy according to one aspect of the present disclosure.

FIG. 5 depicts an example of another process for transparently connecting mobile devices to multiple wireless local area networks according to one aspect of the present disclosure.

FIG. 6 depicts an example of devices in a system for transparently connecting mobile devices to multiple wireless local area networks according to one aspect of the present disclosure.

### DETAILED DESCRIPTION

Certain aspects and features relate to transparently connecting mobile devices to multiple wireless local area networks. For example, if a mobile device connects to a wireless local area network (“WLAN”) via an access point at a first location and subsequently encounters an access point for another WLAN at a second location, the authentication or authorization performed at the first location allows the mobile device to connect to the access point at the second location. The connection at the second location is established without requiring a user of the mobile device to reenter authentication information, to accept terms or conditions for use of the second WLAN, or to perform any other function requiring user input prior to connecting the mobile device to the second WLAN. In some aspects, these features allow a mobile device to seamless “roam” between different WLAN's.

The seamless WLAN roaming functionality described above is made possible due to the different access points that allow the mobile device to connect to the first WLAN and the second WLAN being under common management by a back-end service. The mobile device executes a management application to communicate with the back-end service via a wide area network (“WAN”), e.g., cellular, cable, or DSL network, to determine whether any of the access points for the WLANs within range of the mobile device are under management of the back-end service. If so, the back-end service and the management application may communicate to automatically connect, authenticate, and authorize the mobile device to use the relevant WLAN access point. These and other details of certain aspects are explained in more detail below.

As mentioned, in accordance with some aspects, a mobile device executes a management application that manages the device's connections to different WLAN's. The management application determines that a mobile device is within a communication range of a first access point for a first WLAN. The management application causes the mobile device to present an interface for performing authenticating the mobile device, authorizing the mobile device to connect to the first WLAN, or both. The mobile device is connected to the first WLAN based on input received via the interface (e.g., user credentials, acceptance of terms and conditions for accessing the WLAN, etc.). After the mobile device connects to the first WLAN, the management application determines that the mobile device is within a communication range of a second access point for a second WLAN. For example, the mobile device may be carried into a second geographic location serviced by the second WLAN, where the second WLAN includes access points or other equipment known to a back-end service in communication with the management application.

The management application may communicate with the back-end service via a WAN, or may communicate directly with the second access point, to ultimately determine that a common access policy governs both a first service set identifier (“SSID”) for the first access point and a second SSID for the second access point. For example, an access policy may associate multiple SSIDs with the same terms and conditions, which can allow a given device to access multiple networks corresponding to the SSIDs after being authenticated and authorized to access any of the SSIDs. The mobile device is connected to the second WLAN based on the first and second SSIDs being governed by a common access policy. For example, the management application determines that the mobile device is permitted to access the second WLAN via the second access point without presenting an authentication or authorization interface at the mobile device.

As used herein, the term “mobile device” can include a computing device capable of establishing wireless connections at multiple geographic locations. Examples of a mobile device include (but are not limited to) a laptop, mobile device, mobile computing device, tablet, Internet-of-things device.

As used herein, the term “authenticate” can include determining that a device has provided known credentials associated with a particular identity, account, or subscription. For example, a mobile device can be authenticated for access to a WLAN by providing an appropriate password associated with an SSID of the WLAN.

As used herein, the term “authorized” refers to a user having permission to access the WLAN based on the user's identity, subscription, or other terms or conditions imposed upon the use of a WLAN. For example, a mobile device may be authorized to use a WLAN without requiring the mobile device to submit credentials for authenticating the mobile device.

As used herein, the term “connect” can include establishing a communication channel between a mobile device and a WLAN via which the mobile device can access other network devices or other data networks via the WLAN. A connection to a WLAN can be established via any suitable wired or wireless method. A connection to a WLAN uses any suitable protocol, such as (but not limited to) Wi-Fi.

As used herein, the term “access policy” can include data associating SSIDs with terms and conditions for accessing WLAN's. The access policy can indicate that if a given device is authorized or authenticated for accessing one WLAN corresponding to an SSID in the access policy, then the same device is likewise authorized or authenticated for accessing any WLAN corresponding to any SSID in the access policy.

The foregoing illustrative examples are given to introduce the general subject matter discussed herein and are not intended to limit the scope of the disclosed concepts. The following sections describe various additional aspects and examples with reference to the drawings in which like numerals indicate like elements. The features discussed herein are not limited to any particular hardware architecture and/or configuration. A computing device can include any suitable arrangement of components that provide a result conditioned on at least one input. Suitable computing devices include multipurpose microprocessor-based computer systems accessing stored software that programs and/or configures the computing system from a general-purpose computing apparatus to a specialized computing apparatus implementing one or more aspects of the present subject matter. Any suitable programming, scripting, and/or other type of language and/or combinations of languages may be used to implement the teachings contained herein in software to be used in programming and/or configuring a computing device. Aspects and features from each example disclosed can be combined with any other example.

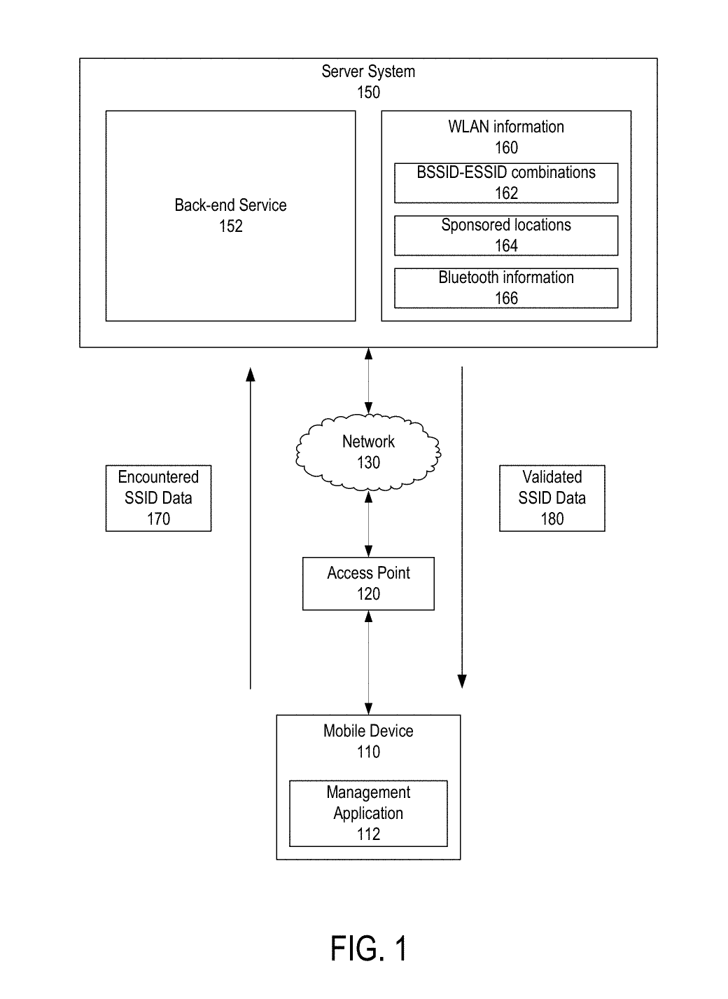

Turning now to the drawings, FIG. 1 is a block diagram depicting an example of a mobile device 110 receiving SSID data that is used for transparently connecting the mobile device 110 to multiple WLAN's. The mobile device 110 executes a management application 112 that can communicate with a back-end service 152, which is executed by a server system 150. For example, the management application 112 can cause the mobile device 110 to communicate with the server system 150 via a WAN and/or via an access point 120, which is connected to a data network 130. Details of how this communication enables transparent connection of the mobile device 110 to multiple WLAN's are described herein.

The management application 112 can operate in the background on the mobile device 110. The management application 112 determines which access point SSIDs have been encountered by the mobile device 110 (e.g., SSIDs that are broadcast or transmitted by access points within communication range of the mobile device 110). For a given WLAN, the SSID information can identify both an Extended Service Set Identification (“ESSID”), which is a human-readable component specific to the WLAN, e.g. “Free Wifi Network,” and a Basic Service Set Identification (“BSSID”), which is a unique hardware identifier for a specific access point.

The back-end service 152 can maintain a database or other data store in which WLAN access point information 160 is stored. This WLAN access point information 160 can include multiple BSSID-ESSID combinations 162 for different WLAN access points. This WLAN access point information 160 can also include associations between certain sponsored locations 164 (e.g., stores or other service-provider locations). In some aspects, the back-end service 152 can also maintain a list of Bluetooth beacons 166 or Bluetooth information associated with the sponsored locations 164. The WLAN access point information 160 maintained by the back-end service 152 (or otherwise accessible to the back-end service 152) can be used to facilitate a transparent connection to multiple access points by the mobile device 110.

For example, the management application 112 may communicate with the back-end service 152 via a WAN (e.g., by creating a secure connection usable by only the management application 112) to determine compatibility with any of the WLAN's access points within the communication range of the mobile device 110. In the example depicted in FIG. 1, the management application 112 causes the mobile device 110 to transmit, via the WAN to the back-end service 152, encountered-SSID data 170 by the mobile device 110. The back-end service 152 responds by transmitting, via the WAN to the management application 112, validated SSID data 180, which may be used by the mobile device 110 to transparently connect to different access points. For example, the back-end service 152 may transmit a hashed table of validated BSSID-ESSID combinations 162. The hashed table of validated ESSIDs and BSSIDs can indicate that the management application 112 is authorized to connect the mobile device 110 to WLAN's via access points associated with those BSSID-ESSID combinations 162. As noted, when connecting to the access point 120, the management application 112 may present an interface requiring the user to enter authentication information (user name, password, etc.) and/or to review and accept terms of service before the mobile device 110 is authenticated and authorized to access the access point 120.

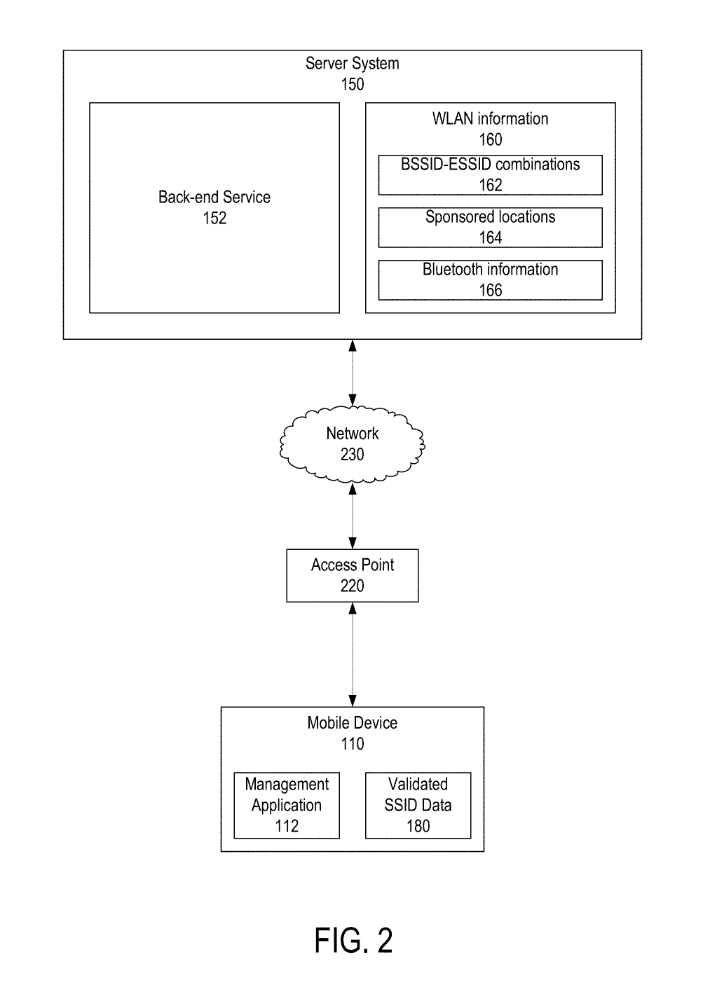

FIG. 2 is a block diagram depicting an example of the mobile device 110 in FIG. 1 using the received validated SSID data 180 for transparently connecting to an access point 220 of a WLAN. The mobile device 110 stores the validated SSID data 180 that was received from the back-end service 152 when establishing a connection to the access point 120. In FIG. 2, the mobile device 110 is in a location serviced by the access point 220. In some aspects, the management application 112 communicates with the back-end service 152 via the WAN in the same manner described in regards to FIG. 1 and the back-end service 152 may determine that the access point 220 is under its management and is governed by the same access policy as the access point 120 (e.g., the access point 220 can have a valid BSSID-ESSID combination 162, which is associated with the same access policy as the validated BSSID-ESSID combination 162 of access point 120). In additional or alternative aspects, the access point 220 may broadcast or transmit its access policy and the management application 112 may determine whether the access policy of access point 220 is the same as the access policy of access point 120.

Based on the management application 112 determining that the access point 220 corresponds to a valid BSSID-ESSID combination 162 or otherwise shares a common access policy with access point 120, the management application 112 can use authentications, authorizations, or both that have been performed via the access point 120 to transparently connect the mobile device 110 to the access point 220. Transparently connecting the mobile device 110 to the access point 220 can include, for example, authorizing the mobile device 110 to access the WLAN associated with the access point 220 without presenting an interface to a user that elicits authentication information (e.g., usernames, passwords, or other credentials) or authorization information (e.g. an acceptance of terms or conditions for using the WLAN).

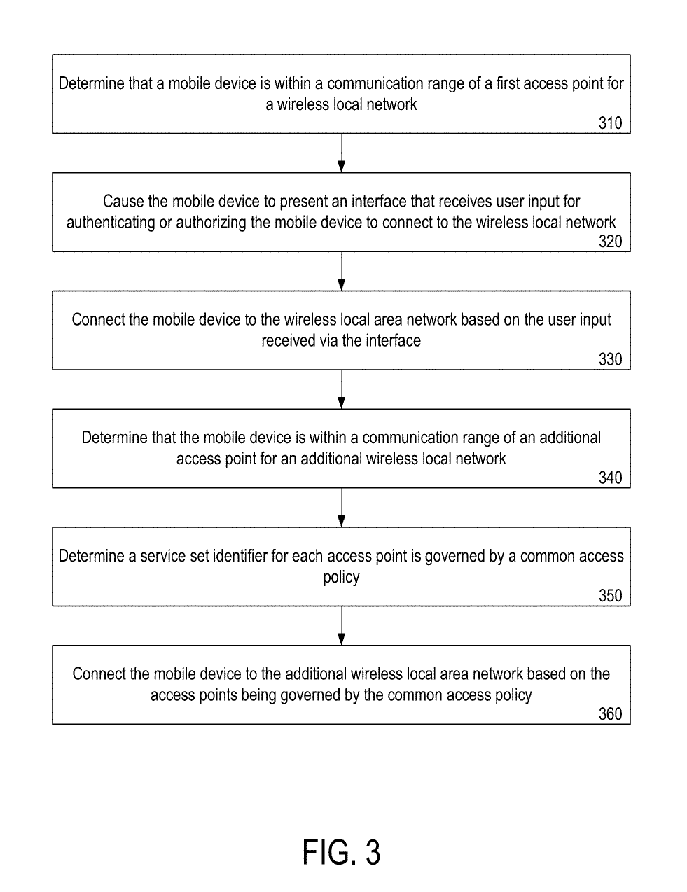

FIG. 3 is a flow chart depicting an example of a process for transparently connecting mobile devices to multiple WLAN's, according to some aspects. For illustrative purposes, this process is described with respect to the examples depicted in FIGS. 1 and 2. However, other implementations are possible.

In block 310, the process involves determining that a mobile device is within a communication range of a first access point for a WLAN. For example, a processing device, which executes the back-end service 152 in the server system 150, can determine that the mobile device 110 is within a communication range of access point 120 for a first WLAN. The back-end service 152 can receive a wireless signal from the mobile device 110 via one or more networks 130, 230. The signal can include encountered-SSID data 170. The encountered-SSID data 170 may not include validated SSID data 180, and the back-end service 152 may request the additional authentication or authorization information from the mobile device 110.

In block 320, the process involves causing the mobile device to present an interface that receives user input. In this example, the processing device in the server system 150 can cause the mobile device 110 to present an interface that receives user input from a user of the mobile device 110. The user input can be used for authenticating the mobile device 110, authorizing the mobile device 110 to connect to the first WLAN, or both. The server system 150 can cause the mobile device to present the interface by requesting the additional authentication or authorization information.

In block 330, the process involves connecting the mobile device to the first WLAN based on the user input received via the interface. In this example, the processing device in the server system 150 can connect the mobile device 110 to the first WLAN based on the user input received via the interface. The back-end service 152 can receive the authentication information from the mobile device 110. The authentication information indicates that the user associated with the mobile device agrees to certain terms and conditions. In response, the back-end service 152 can provide the mobile device 110 with validated SSID data 180.

In block 340, the process involves determining that the mobile device is within a communication range of a second access point for a second WLAN. In this example, the processing device in the server system 150 can determine that the mobile device 110 is within a communication range of the access point 220. The mobile device can be a mobile phone being carried by a user between stores. The first access point may be in a first store and the second access point may be in a second store. The back-end service 152 may receive wireless signals from the mobile device including the validated SSID data 180.

In block 350, the process involves determining that a first SSID for the first access point and a second SSID for the second access point are governed by a common access policy. In this example, the processing device in the server system 150 can determine that a validated SSID 180 for the access point 120 is governed by a common access policy as the validated SSID 180 for the access point 220. The back-end service 152 may determine that the validated SSID data 180, which is provided by the mobile device 110, authorizes the mobile device 110 to connect to the second WLAN.

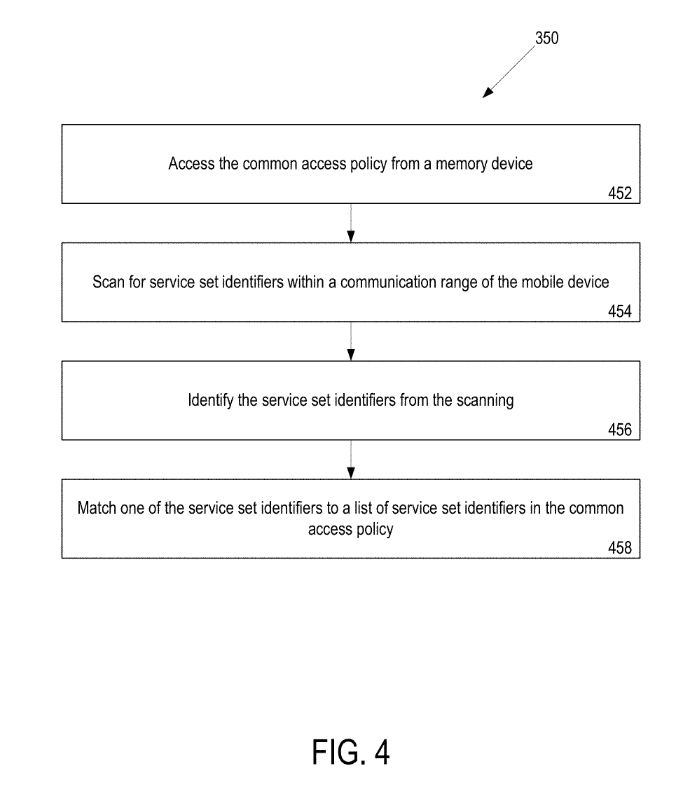

FIG. 4 is a flow chart depicting an example of a process for performing block 350 in FIG. 1. However, other implementations are possible.

In block 452, the common access policy is accessed from a non-transitory computer-readable medium. The common access policy can include a list of SSIDs and indicate WLANs for which the mobile device is authenticated or authorized. In block 454, the SSIDs within a communication range of the mobile device can be scanned for. In block 456, the first SSID and the second SSID can be identified from scanning the SSIDs within the communication range of the mobile device. In block 458, the first SSID and the second SSID can be matched to the list of SSIDs in the common access policy.

Returning to FIG. 3, in block 360, the process involves connecting the mobile device to the second WLAN based on the first SSID and the second SSID being governed by the common access policy. In this example, the processing device in the server system 150 can connect the mobile device 110 to the second WLAN based on the validated SSID 180 for the access point 120 being governed by a common access policy as the validated SSID 180 for the access point 220.

In some aspects, the management application 112 may not present the interface on the mobile device 110 when the mobile device 110 is within the communication range of the access point 220 based on the first SSID and the second SSID being governed by the common access policy. The back-end service 152 may cause the management application to avoid presenting the interface, which can reduce the time for the mobile device to be connected to the second WLAN.

In some aspects, the server system 150 can determine, subsequent to connecting the mobile device 110 to the WLAN, that the mobile device is within a communication range of a third access point for a third wireless local area network. The server system 150 can determine that a third SSID for the third access point is governed by the common access policy. The server system 150 can further determine that an update to the common access policy occurred subsequent to the mobile device 110 being connected to the second WLAN. The server system 150 can cause, based on identifying the update, the mobile device 110 to present an additional interface for authenticating or authorizing the mobile device 110 to connect to the third WLAN.

In additional or alternative aspects, the server system 150 can match the second SSID to a product or a service provider. The server system 150 can determine that the mobile device 110 is in a geographic location corresponding to the product or the service provider based on a connection of the mobile device 110 to the second WLAN. Based on determining that the mobile device 110 is in the geographic location, the server system 150 can cause the mobile device to present promotional content for the product or service provider.

Although FIG. 3 describes a process for a single mobile device to be transparently connected to multiple WLANS, other implementations are possible. For example, multiple mobile devices may be associated with a common user (e.g., a mobile phone and a tablet may be associated with a single user). The server system 150 can determine, subsequent to connecting the first mobile device to the first WLAN, that the second mobile device is within a communication range of the second access point for a second WLAN. The server system 150 can determine that a first mobile device and a second mobile device are associated with a common user. In some aspects, the server system 150 can determine identity data associated with a user of the first mobile device based on the user input received via the interface. The server system 150 can access a list of mobile devices associated with the user from a non-transitory computer-readable medium using the identity data. The server system 150 can match the identity data associated with the first mobile device with the second mobile device based on the list of mobile devices. The server system 150 can further determine to connect the second mobile device to the second WLAN based on the first mobile device and the second mobile device having a common user.

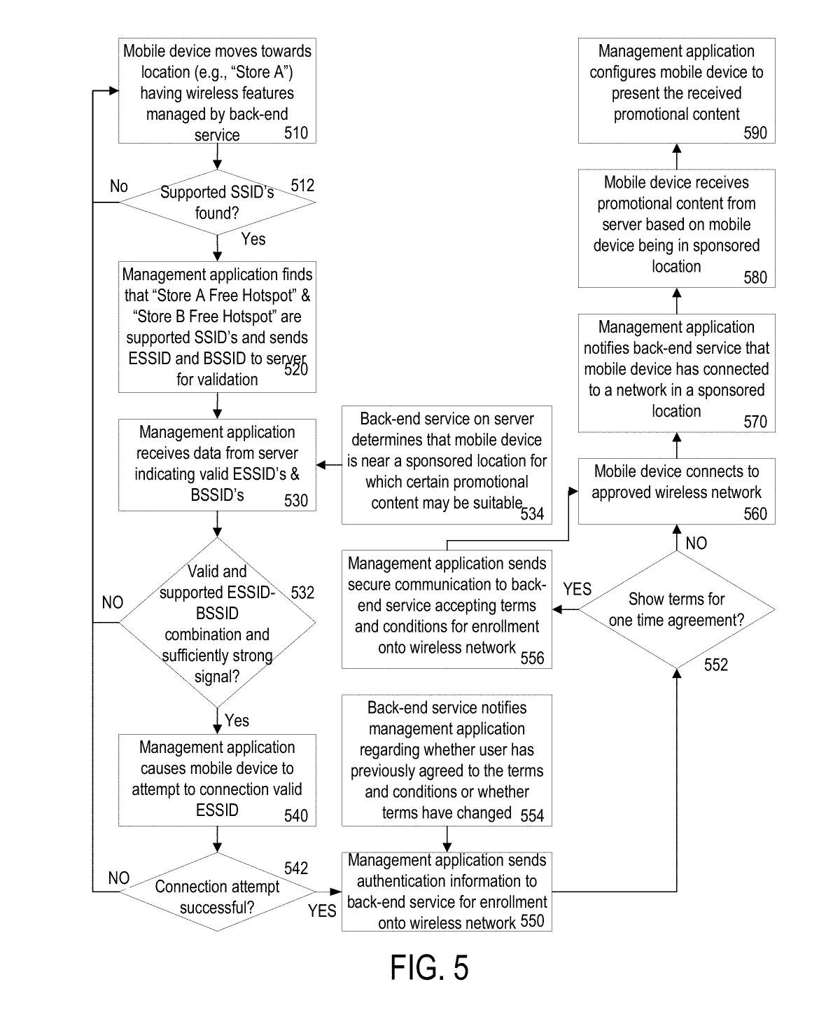

FIG. 5 is a flow chart depicting another example of a process for transparently connecting mobile devices to multiple WLAN's, according to some aspects. For illustrative purposes, this process is described with respect to the examples depicted in FIGS. 1 and 2. However, other implementations are possible.

In block 510, the process involves the mobile device 110 moving towards a location (e.g., a “Store A”) having wireless features (e.g., access point(s) broadcasting SSID data or other wireless information, a wireless backbone, etc.) that are managed by the back-end service 152 executed on the server system 150. The management application 112 or another suitable application executed on the mobile device 110 can monitor for access points 120, 220 within a communication range of the mobile device 110. For example, the management application 112 can determine that one or more access points 120, 220 within a communication range of the mobile device 110 are broadcasting or otherwise transmitting SSID information.

In block 512, the management application 112, which is executed on the mobile device 110, determines whether supported SSIDs have been encountered by the mobile device. As used herein, the distinction between the term “supported” and “valid” refers to BSSID-ESSID combinations 162. An ESSID may be supported, while a BSSID-ESSID combination 162 may be not valid. For example, a situation where any access point not managed by the back-end service having a supported ESSID such as “Free WIFI” means the SSID/ESSID is supported and recognized by the mobile device 110. However, after the mobile device 110 communicates the SSID to the back-end service 152, the back-end service 152 determines that the included BSSID-ESSID combination 162 (e.g., an ESSID of “Free WIFI” with the BSSID of “AABBCCDDEE”) is not valid due to that entry not being recognized on the server system 150. If the ESSID and BSSID are not valid, the access point is not under the management of the back-end service 152. Ensuring that the access point 120, 220 has an SSID this is both supported and valid before enabling the mobile device 110 to connect to the access point 120, 220 prevents the mobile device 110 from connecting to an access point having a fake ESSID, which can be created by any individual, and provides a level of security on behalf of the customer. If the management application 112 determines that no supported SSIDs have been encountered by the mobile device 110, the management application 112 continues monitoring for other access points 120, 220 (and their associated SSIDs) within a communication range of the mobile device 110.

If the management application 112 determines that supported SSIDs have been encountered by the mobile device 110, the process proceeds to block 520. In block 520, the management application 112 causes the mobile device 100 to transmit WLAN information (e.g., one or more ESSIDs and one or more BSSIDs) to the server system 150 for validation by the back-end service 152. The mobile device 110 transmits the WLAN information about encountered access points via any suitable manner. In some aspects, the mobile device 110 transmits the WLAN information to the server system 150 via a secure connection established using a WAN (e.g., telecommunication network). In additional or alternative aspects, the mobile device 110 transmits the WLAN information via temporary access to a WLAN access point (again, establishing a secure connection usable by only the management application). In other aspects, the management application 112 may provide GPS information to the back-end service 152 as to the geographic region in which the mobile device 110 is located.

The back-end service 152 can send, to the management application 112, an updated list of supported SSIDs in the area and the associated valid BSSID-ESSID combinations 162. In the event the connection between the management application 112 and the back-end service 152 is subsequently lost (e.g., cellular signal is poor or subsequently disconnected), the management application 112 can use the updated list of valid BSSID-ESSID combinations 162 to seamlessly connect to supported and valid WLAN access points 120, 220.

For example, the management application 112 can determine that “Store A Free Hotspot” and “Store B Free Hotspot” are supported SSIDs, and can cause the mobile device to transmit an BSSID-ESSID combination 162 for “Store A Free Hotspot” and an BSSID-ESSID combination 162 for “Store B Free Hotspot” to the back-end service 152. Examples of BSSID-ESSID combinations 162 can include (i) “Store A Free Hotspot,” “AA11BB22CC33”; (ii) “Store A Free Hotspot,” “AB11BB22CC33”; (iii) “Store A Free Hotspot,” “AC11BB22CC33”; (iv) “Store A Free Hotspot,” “AD11BB22CC33”; (v) “Store B Free Hotspot,” “AE11BB22CC33”; and (vi) “Store B Free Hotspot,” “AF11BB22CC33.”

In block 530, the management application 112 receives, from the back-end service 152, data indicating that certain ESSIDs and BSSIDs are supported and are validated by the back-end service 152. In some aspects, the management application 112 receives a list of BSSID-ESSID combinations 162 along with a yes/no indicator of whether the ESSID-BSSID combination 162 has been validated by the back-end service 152. Continuing with the example above, this list may include the following BSSID-ESSID combinations 162 and yes/no indicators: (i) “Store A Free Hotspot,” “AA11BB22CC33,” “Y;” (ii) “Store A Free Hotspot,” “AB11BB22CC33,” “Y;” (iii) “Store A Free Hotspot,” “AC11BB22CC33,” “N;” (iv) “Store A Free Hotspot,” “AD11BB22CC33,” “Y;” (v) “Store B Free Hotspot,” “AE11BB22CC33,” “Y;” and (vi) “Store B Free Hotspot,” “AF11BB22CC33,” “Y.”

In block 534, the back-end service 152 determines that the mobile device 110 is near a sponsored location 164 for which certain promotional content may be suitable. An example of a sponsored location 164 is a store having a WLAN for which certain wireless features (e.g., SSID data or other wireless information, a wireless backbone, etc.) are managed by the back-end service 152. The back-end service 152 can determine that the mobile device 110 is near a sponsored location 164 even if, for example, the mobile device 110 does not enter a store or other building at the sponsored location 164. The back-end service 152 or other suitable application on the server system can respond to this determination by pushing or otherwise transmitting promotional content (e.g., a coupon for a given store) to the management application 112 on the mobile device 110. The management application 112 can cause the mobile device 110 to display or otherwise present the promotional content, which may induce a user of the mobile device 110 to enter the store or otherwise move toward the sponsored location 164.

In block 532, the management application 112 determines whether any of the valid and supported BSSID-ESSID combinations 162 are associated with an access point 120, 220 having a sufficiently strong signal. For instance, the management application 112 analyzes received signal strength indicators (“RSSI”) and thereby determines whether any signals received from access points 120, 220 corresponding to the BSSID-ESSID combinations 162 have a signal strength above a threshold signal level. If the management application 112 determines that no valid and supported BSSID-ESSID combinations 162 are associated with an access point having a sufficiently strong signal, the management application 112 continues monitoring for other access points 120, 220 (and their associated SSIDs) within a communication range of the mobile device 110.

If the management application determines that at least one valid and supported BSSID-ESSID combination 162 is associated with an access point 120, 220 having a sufficiently strong signal, the process can proceed to block 540. In block 540, the management application 112 causes the mobile device 110 to attempt a connection with the access point 120 associated with the valid BSSID-ESSID combination 162. In block 542, the management application determines if the connection is successful. If the connection is unsuccessful, the management application 112 continues monitoring for other access points 120, 220 (and their associated SSIDs) within a communication range of the mobile device 110.

If the mobile device successfully connects to the access point, the process proceeds to block 550. In block 550, the mobile device 110 communicates with the back-end service 152 to determine whether additional authorization information, authentication information, or both must be received from the user of the mobile device 110 to enable wireless communication via the supported WLAN (i.e., the WLAN corresponding to the valid BSSID-ESSID combination 162). For example, in block 554, the back-end service 152 transmits a notification to the management application 112 indicating whether a user of the mobile device 110 has previously agreed to certain terms and conditions associated with using the WLAN. Additionally or alternatively, the back-end service 152 can transmit a notification to the management application 112 indicating whether terms and conditions associated with using the WLAN have been updated or otherwise changed since the last time the mobile device 110 connected to the WLAN.

Block 550 further involves the mobile device 110 transmitting authentication information to the back-end service 152 for enrollment onto the WLAN. In some aspects, the management application 112 or another suitable application on the mobile device 110 determines whether authentication information, which has previously resulted in a successful authentication of the mobile device 110 or its user, is stored on the mobile device 110 or otherwise accessible to the mobile device 110. If this authentication information is not available to the mobile device 110, the management application 112 or another suitable application causes the mobile device 110 to present an interface to the user. The authentication information can be received by the mobile device 110 via the interface. If this authentication information is available to the mobile device 110, the management application 112 or another suitable application retrieves the authentication information without causing the mobile device 110 to present an interface to the user. The management application 112 causes the mobile device 110 to transmit the received or retrieved authentication information to a suitable computing system (e.g., the server system 150 or another computing system that manages authentication for the WLAN), thereby causing the mobile device 110 to be authenticated for enrollment onto the WLAN.

In block 552, the mobile device 110 determines whether terms and conditions should be presented to the user prior to authorizing the mobile device 110 to access the WLAN. For example, a notification received by the management application from the back-end service 152 indicates whether the terms and conditions should be displayed (e.g., whether the user has previously accepted the terms and conditions or whether the terms and conditions have changed since a previous acceptance by the user).

If the terms and conditions are to be presented to the user, the process proceeds to block 560. In block 560, the management application 112 causes the mobile device to present an interface for accepting the terms and conditions. The management application 112 can receive input via the interface indicating the user's acceptance of the terms and conditions. The management application 112 responds to the user's acceptance of the terms and conditions by authorizing the mobile device 110 to access the WLAN. Then the process proceeds to block 560. Returning to block 552, if the terms and conditions do not need to be presented to the user, the process proceeds to block 560 without presenting an interface for accepting the terms and conditions. In block 560, the management application 112 authorizes the mobile device to access the WLAN.

In block 570, the management application 112 notifies the back-end service 152 that the mobile device 110 has connected to a network in a sponsored location. In block 580, the mobile device 110 receives promotional content (e.g., loyalty coupons, advertisements, etc.) from the server system 150, where the server system 150 transmits the promotional content based on the mobile device 110 being in a sponsored location 164.

The use of the network connection to identify the mobile device 110 being in a sponsored location can provide a more accurate method of location tracking and targeted content delivery as compared to solutions using GPS for tracking mobile devices. GPS-based solutions may not be useful for distinguishing between a user being inside the store and the user simply walking by the store. Furthermore, with GPS, even after a user has walked inside a store, the signal from a mobile device may not be not accurate enough to determine that the user is still inside of the store after a certain period.

By contrast, the management application 112 described herein can be used to provide accurate location information regarding a user. For example, if the mobile device 110 connects to a given access point corresponding to an BSSID-ESSID combination 162, this connection can provide information regarding a user's location (e.g., whether a user is entering a location from a certain entrance, whether the user is on a certain floor of a building, etc.). This information can also be used to ensure that a user has in fact walked into the store or other sponsored location 164 (e.g., by determining that the mobile device 110 has connected to an access point 120, 220 located in the middle of the store).

In block 590, the management application 112 causes the mobile device 110 to present promotional content received from the back-end service 152 or other online service. In some aspects, the management application 112 generates or accesses a container corresponding to the sponsored location 164 (e.g., software emulating an application specific to the sponsored location 164, such as a store's shopping application). The management application 112 executes or otherwise uses the container to present an interface for soliciting user inputs related to the sponsored location 164 (e.g., searching for an item, requesting a price check, etc.). The management application 112 causes the mobile device 110 to communicate with an online service associated with the sponsored location 164. For example, the management application 112 can send data associated with the received input to the online service (e.g., a request for a price check), receive responsive data from the online service (e.g., the price for the requested item), and execute or otherwise use the container to output the responsive data (e.g., updating the interface to include the price for the requested item).

In some aspects, the management application 112 provides a multi-tenant functionality. The management application 112 can be a single-instance download from an online application store. The management application 112 can change an interface presented on the mobile device 110 based on the mobile device 110 connecting to a WLAN for a given store or other sponsored location 164 (e.g., by using the container described above). For example, if a mobile device 110 connects to an access point 120 located in Store A, the management application 112 can generate an interface that has the look and feel of a custom mobile application designed by an operator of Store A. If the mobile device 110 subsequently connects to the access point 220 located in Store B, the management application 112 can generate a different interface that has the look and feel of a custom mobile application designed by an operator of Store B. In these aspects, the management application 112 reduces or removes the need to download multiple applications for multiple stores or other sponsored locations 164. In this manner, the management application 112 can provide an improved end-user experience while also improving the operation of the mobile device 110 (e.g., by preventing storage space from being occupied by multiple applications, by preventing processing resources from being occupied by concurrently executing applications from different stores, etc.).

In some aspects, if the management application does not support certain functionality for accessing an online service associated with a sponsored location 164 (e.g., a store's online shopping service), the management application 112 can cause the mobile device 110 to execute a mobile application that is independent of the management application 112. For example, if the management application 112 does not have the ability to check invoice information for a given store, and the user wishes to use that feature, the management application 112 can offer to execute a separate application stored on the mobile device 110 for that store. This can reduce the need for the user to manually navigate to the application specific to the store.

In some circumstances in which many tenants are co-located (e.g., a mall having multiple sponsored locations 164), the management application 112 can either present the user with the option to connect to a specific store or allow the application to be triggered by a Bluetooth beacon 166. A Bluetooth beacon 166 can be placed at the recessed entrance of the store and the management application 112 can make the logical decision to switch from store to store.

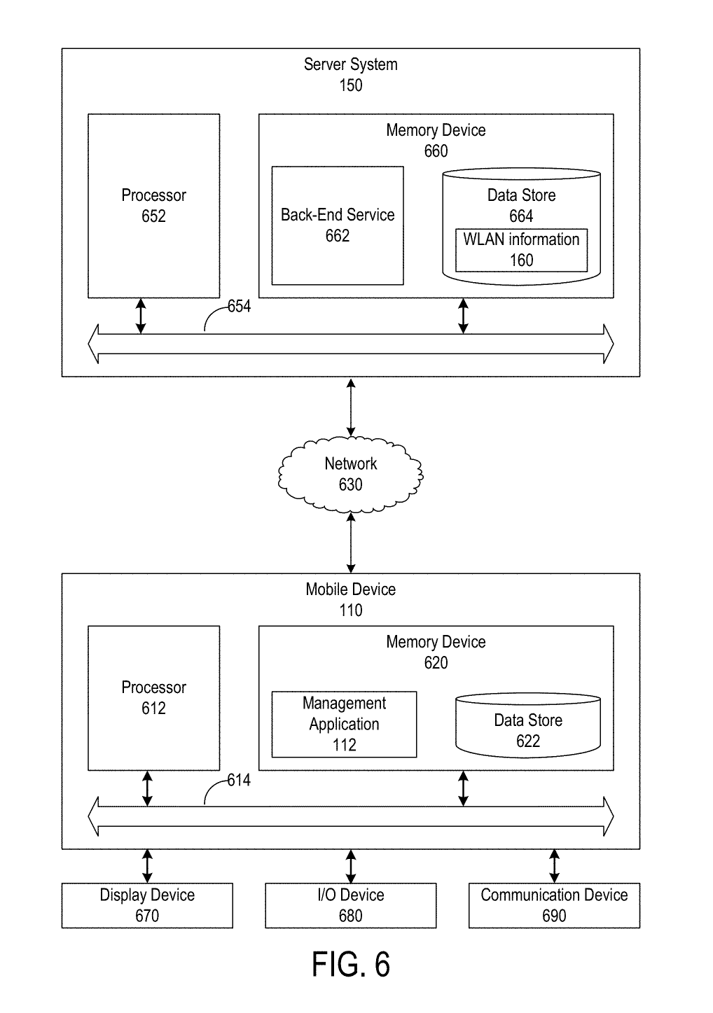

Any suitable device can be used to implement the aspects described herein. For example, FIG. 6 is a block diagram depicting examples of computing devices for implementing certain aspects of the present disclosure. The computing devices include the server system 150 and the mobile device 110 depicted in FIGS. 1 and 2 in communication via a network 630. A general discussion of the components of the server system 150 and the mobile device 110 is provided below.

The server system 150 may include at least one server computer or any other system providing capabilities for managing access to resources and/or distributing resources to mobile devices. In some aspects, multiple server systems may be employed that are included in at least one server bank, computer banks, or other arrangements. For example, multiple server systems may be included to provide a cloud computing resource, a grid computing resource, and/or any other distributed computing arrangement. Such server systems may be located in a single installation or may be distributed among many different geographic locations. For purposes of convenience, the server system 150 is referred to herein in the singular. Even though the server system 150 is referred to in the singular, it is understood that multiple server systems may be employed in the arrangements as descried herein.

The mobile device 110 can include any suitable computing device or system for communicating via the network 630 and executing at least one application. Non-limiting examples of a mobile device include a laptop computer, a personal digital assistant, a cellular telephone, a set-top box, a music player, a web pad, a tablet computer system, or another device with similar capability. The mobile device 110 may be included to execute various applications. For example, the mobile device 110 may be included to execute applications such as web browsing applications, email applications, instant messaging applications, and/or other applications capable of receiving and/or rendering resources on a display associated with the mobile device 110.

The server system 150 and the mobile device 100 include processors 612, 652. Each of the processors 612, 652 may be a microprocessor, an application-specific integrated circuit (“ASIC”), or other suitable processing device. Each of the processors 612, 652 can include any number of computer processing devices, including one. Each of the processors 612, 652 can be communicatively coupled to a computer-readable medium, such as the memory devices 620, 660. Each of the processors 612, 652 can execute computer-executable program instructions and/or accesses information respectively stored in the memory device 660 of the server system 150 and in the memory device 620 of the mobile device 110.

Each of the memory devices 620, 660 can include a computer-readable medium or other memory device. A computer-readable medium or other memory device can include both volatile and nonvolatile memory and data storage components. Volatile components are those that do not retain data values upon loss of power. Nonvolatile components include memory components that retain data upon a loss of power. A computer-readable medium may include (but is not limited to) an electronic, optical, magnetic, or other storage device capable of providing a processor with computer-readable instructions. Other examples comprise, but are not limited to, magnetic disk or other magnetic storage, memory chip, read-only memory (“ROM”), random access memory (“RAM”), an ASIC, a configured processor, optical storage accessed via an optical medium drive, solid-state drives, USB flash drives, memory cards accessed via a memory card reader, magnetic tapes accessed via an appropriate tape drive, and/or other memory components, or a combination of any two or more of these memory components. RAM may include, for example, static random access memory (“SRAM”), dynamic random access memory (“DRAM”), or magnetic random access memory (“MRAM”) and other such devices. ROM may comprise, for example, a programmable read-only memory (“PROM”), an erasable programmable read-only memory (“EPROM”), an electrically erasable programmable read-only memory (“EEPROM”), or other like memory device.

The processor 652 and the memory device 660 of the server system 150 may be communicatively coupled to a local interface 654. The processor 612 and the memory device 620 of the mobile device 110 may be communicatively coupled to a local interface 614. A local interface can include, for example, a data bus with an accompanying address/control bus or other bus structure. One or more of the processors 612, 652 may represent multiple processing devices and one or more of the memory devices 620, 660 may represent multiple memory devices that operate in parallel processing circuits, respectively. In such a case, one or more of the local interfaces 614, 654 may include an appropriate network that facilitates communication between any two of the multiple processors or between any two of the multiple memory devices 620, 660. The local interfaces may comprise additional systems designed to coordinate this communication, including, for example, performing load balancing.

The mobile device 110 may also include a number of external or internal devices such as a mouse, a keyboard, a display, audio speakers, one or more microphones, or any other input or output devices 680. For example, the mobile device 110 may include or be in data communication with a display device 670. A non-limiting example of a display device is a computer screen, such as a touch screen. Although FIG. 6 depicts the display device 670 as a separate device coupled to the mobile device 110, the display device 670 can be integrated into the mobile device.

The mobile device can also include a communication device 690. The communication device 690 can include one or more communication components including a wired network connectivity component such as, for example, an Ethernet network adapter, a modem, and/or the like. The mobile device 110 may further include a wireless network connectivity interface, for example, a Peripheral Component Interconnect (“PCI”) card, a Universal Serial Bus (“USB”) interface, a Personal Computer Memory Card International Association (“PCMCIA”) card, Secure Digital Input-Output (“SDIO”) card, NewCard, Cardbus, a modem, a wireless radio transceiver, a cellular radio, and/or the like. The mobile device 110 may be operable to communicate via wired connection with the server system 150 with the aid of the wired network connectivity component. The mobile device 110 may be further operable to communicate wirelessly with the server system 150 with the aid of the wireless network connectivity component.

Instructions stored in the memory device 660 of the server system 150 and executable by its processor 652 can include a back-end service and/or other applications. The back-end service can include at least one function for controlling resources executed at computing devices such as mobile device 110, as described in detail herein. Certain data may be stored in a data store 664 of the memory device 660 that is part of or otherwise accessible to the server system 150. The illustrated data store 664 may be representative of a multiple data stores, as can be appreciated.

Instructions stored in the memory device 620 of the mobile device 110 and executable by its processor 612 can include a back-end service and/or other applications. The back-end service can include at least one function for controlling resources executed at computing devices such as mobile device 110, as described in detail herein. Certain data may be stored in a data store 622 of the memory device 620 that is part of or otherwise accessible to the mobile device 110. The illustrated data store 622 may be representative of multiple data stores. The data stored in the data store 622 may be associated with the operation of certain applications and/or functional entities described herein.

As used herein, the term “computer-executable program instructions” is used to refer to a program file that is in a form that can ultimately be run by a processor. Examples of computer-executable program instructions may be, for example, a compiled program that can be translated into machine code in a format that can be loaded into a random access portion of a memory and executed by a processor, source code that may be expressed in proper format such as object code that can be loaded into a random access portion of a memory and executed by a processor, source code that may be interpreted by another executable program to generate instructions in a random access portion of a memory and executed by a processor, and the like. The instructions may comprise processor-specific instructions generated by a compiler and/or an interpreter from code written in any suitable computer-programming language, including, for example, C, C++, C#, Objective-C, PHP, Visual Basic, Java, Python, Perl, JavaScript, and ActionScript. An executable program may be stored in any portion or component of a memory device such as, for example, RAM, ROM, a hard drive, solid-state drive, USB flash drive, memory card, optical disc such as compact disc (“CD”) or digital versatile disc (“DVD”), floppy disk, magnetic tape, or other memory components.

The network 630 facilitates communication between the server system 150 and the mobile device 110. The network 630 can include any suitable architecture for providing communication channels between the mobile device 110 and the server system 150. A communication channel can include any suitable means capable of communicating signals between the mobile device 110 and the server system 150. Non-limiting examples of the network 630 include any type of wired network, wireless network, or a combination of wired and wireless networks. A wireless network may be a WLAN (“WLAN”), a wireless wide area network (“WWAN”), or any other type of wireless network now known or later developed. Additionally, the network 630 may be or include the Internet, intranets, extranets, microwave networks, satellite communications, cellular systems, personal communication services (“PCS”), infrared communications, global area networks, or other suitable networks, etc., or any combination of two or more such networks.

### General Considerations

The foregoing description of the aspects, including illustrated examples, has been presented only for the purpose of illustration and description and is not intended to be exhaustive or limiting to the precise forms disclosed. Many variations and modifications may be made to the above-described examples without departing substantially from the spirit and principles of the disclosure. All such modifications and variations are intended to be included herein within the scope of this disclosure and protected by the following claims.

The flowcharts described herein show certain functionality and operations performed by the management application, client application, proxy service and compliance service, respectively. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor and in a computer system or other system. The machine code may be converted from the source code, etc. If embodied in hardware, each block may represent a circuit or a number of interconnected circuits to implement the specified logical function(s).

Although the flowcharts described herein show a specific order of execution, it is understood that the order of execution may differ from that which is depicted. For example, the order of execution of two or more steps may be scrambled relative to the order shown. Also, two or more blocks shown in succession in the flow charts may be executed concurrently or with partial concurrence. Further, in some aspects, one or more of the steps shown in the flow charts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Any logic or application described herein that comprises software or code can be embodied in any non-transitory computer-readable medium for use by or in connection with a computing system such as, for example, a processor in a computer system or other system. In this sense, the logic may comprise, for example, statements including instructions and declarations that can be fetched from the computer-readable medium and executed by a computing system.

In the context of the present disclosure, a “computer-readable medium” can include any medium that can contain, store, maintain, or otherwise include the logic or application described herein for use by or in connection with a computing system. The computer-readable medium can comprise any one of many physical media such as, for example, magnetic, optical, or semiconductor media. More specific examples of a suitable computer-readable medium can include, but are not limited to, magnetic tapes, magnetic floppy diskettes, magnetic hard drives, memory cards, solid-state drives, USB flash drives, optical discs, etc. The computer readable medium may be a random access memory (“RAM”). Examples of a RAM can include (but are not limited to) static random access memory (“SRAM”), dynamic random access memory (“DRAM”), magnetic random access memory (“MRAM”), etc. The computer- readable medium may be a read-only memory (“ROM”), a programmable read-only memory (“PROM”), an erasable programmable read-only memory (“EPROM”), an electrically erasable programmable read-only memory (“EEPROM”), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and the following claims.

What is claimed is:

1. A method comprising:
determining, by a processing device, that a mobile device is within a communication range of a first access point for a first wireless local area network;
causing, by the processing device, the mobile device to present an interface that receives user input for at least one of authenticating the mobile device or authorizing the mobile device to connect to the first wireless local area network;
connecting the mobile device to the first wireless local area network based on the user input received via the interface;
determining, by the processing device and subsequent to connecting the mobile device to the first wireless local area network, that the mobile device is within a communication range of a second access point for a second wireless local area network;
determining a first service set identifier for the first access point and a second service set identifier for the second access point are governed by a common access policy; and
connecting the mobile device to the second wireless local area network based on the first service set identifier and the second service set identifier being governed by the common access policy.

2. The method of claim 1, further comprising determining, based on the first service set identifier and the second service set identifier being governed by the common access policy, that the interface should not be presented at the mobile device when the mobile device is within the communication range of the second access point.

3. The method of claim 1, wherein determining that the first service set identifier and the second service set identifier are governed by the common access policy comprises:
accessing the common access policy from a non-transitory computer-readable medium, wherein the common access policy includes a list of service set identifiers and indicates wireless local area networks for which the mobile device is authenticated or authorized;
scanning, by the mobile device, for service set identifiers within a communication range of the mobile device;
identifying the first service set identifier and the second service set identifier from the scanning; and
matching at least one of the first service set identifier or the second service set identifier to the list of service set identifiers in the common access policy.

4. The method of claim 1, further comprising:
determining, by the processing device and subsequent to connecting the mobile device to the second wireless local area network, that the mobile device is within a communication range of a third access point for a third wireless local area network;
determining that a third service set identifier for the third access point is governed by the common access policy;
identifying an update to the common access policy that occurred subsequent to the mobile device being connected to the second wireless local area network; and
causing, by the processing device and based on identifying the update, the mobile device to present an additional interface for performing at least one of authenticating the mobile device or authorizing the mobile device to connect to the third wireless local area network.

5. The method of claim 1, further comprising:
matching, by the processing device, the second service set identifier to a product or service provider;
determining, by the processing device, that the mobile device is in a geographic location corresponding to the product or service provider based on a connection of the mobile device to the second wireless local area network; and
based on determining that the mobile device is in the geographic location, causing the mobile device to present promotional content for the product or service provider.

6. The method of claim 1, wherein the mobile device is a first mobile device of a plurality of mobile devices associated with a user, the method further comprising:
determining, by the processing device and subsequent to connecting the first mobile device to the first wireless local area network, that a second mobile device of the plurality of mobile devices associated with the user is within a communication range of a third access point for a third wireless local area network;
determining the first service set identifier for the first access point and a third service set identifier for the third access point are governed by a common access policy;
determining the first mobile device and the second mobile device are associated with a common user; and
connecting the second mobile device to the third wireless local area network based on the first service set identifier and the third service set identifier being governed by the common access policy, and the first mobile device and the second mobile device being associated with the common user.

7. The method of claim 6, wherein determining the first mobile device and the second mobile device are associated with the common user comprises:
determining identity data associated with the common user based on the user input received via the interface
accessing a list of mobile devices associated with the common user from a non-transitory computer-readable medium using the identity data associated with the common user; and
matching identity data associated with the second mobile device with identity data included in the list of mobile devices associated with the common user.

8. A system comprising:
a first access point for a first wireless local area network, the first access point having a first service set identifier;
a second access point for a second wireless local area network, the second access point having a second service set identifier;
a processing device; and
a memory device on which instructions are stored for causing the processing device to:
determine that a mobile device is within a communication range of the first access point;
cause the mobile device to present an interface that receives user input for at least one of authenticating the mobile device or authorizing the mobile device to connect to the first wireless local area network;
connect the mobile device to the first wireless local area network based on the user input received via the interface;
determine, subsequent to connecting the mobile device to the first wireless local area network, that the mobile device is within a communication range of the second access point;
determine the first service set identifier and the second service set identifier are governed by a common access policy; and
connect the mobile device to the second wireless local area network based on the first service set identifier and the second service set identifier being governed by the common access policy.

9. The system of claim 8, wherein the instructions are further for causing the processing device to determine, based on the first service set identifier and the second service set identifier being governed by the common access policy, that the interface should not be presented at the mobile device when the mobile device is within the communication range of the second access point.

10. The system of claim 8, wherein the instructions for causing the processing device to determine that the first service set identifier and the second service set identifier are governed by the common access policy comprises instructions for causing the processing device to:
access the common access policy from the memory device, wherein the common access policy includes a list of service set identifiers and indicates wireless local area networks for which the mobile device is authenticated or authorized; and
match at least one of the first service set identifier or the second service set identifier to the list of service set identifiers in the common access policy.

11. The system of claim 8, further comprising a third access point for a third wireless local area network, the third access point having a third service set identifier, wherein the instructions are further for causing the processing device to:
determine, subsequent to connecting the mobile device to the second wireless local area network, that the mobile device is within a communication range of the third access point;
determine that the third service set identifier for the third access point is governed by the common access policy;
identify an update to the common access policy that occurred subsequent to the mobile device being connected to the second wireless local area network; and
cause, based on identifying the update, the mobile device to present an additional interface for performing at least one of authenticating the mobile device or authorizing the mobile device to connect to the third wireless local area network.

12. The system of claim 8, wherein the instructions are further for causing the processing device to:
match the second service set identifier to a product or service provider;
determine that the mobile device is in a geographic location corresponding to the product or service provider based on a connection of the mobile device to the second wireless local area network; and
cause, based on determining that the mobile device is in the geographic location, the mobile device to present promotional content for the product or service provider.

13. The system of claim 8, the system further comprising a third access point for a third wireless local area network, the third access point having a third service set identifier, wherein the mobile device is a first mobile device of a plurality of mobile devices associated with a user, the instructions are further for causing the processing device to:
determine, subsequent to connecting the first mobile device to the first wireless local area network, that a second mobile device of the plurality of mobile devices associated with the user is within a communication range of the third access point;
determine the first service set identifier for the first access point and the third service set identifier for the third access point are governed by a common access policy;
determine the first mobile device and the second mobile device are associated with a common user; and
connect the second mobile device to the third wireless local area network based on the first service set identifier and the third service set identifier being governed by the common access policy, and the first mobile device and the second mobile device being associated with the common user.

14. The system of claim 13, wherein the instructions for causing the processing device to determine the first mobile device and the second mobile device are associated with the common user comprises instructions for causing the processing device to:
determine identity data associated with the common user based on the user input received via the interface;
access a list of mobile devices associated with the common user from the memory device using the identity data associated with the common user; and
match identity data associated with the second mobile device with identity data included in the list of mobile devices associated with the common user.

15. A non-transitory computer-readable medium in which instructions are stored, the instructions being executable by a processing device for causing the processing device to:
determine that a first mobile device is within a communication range of a first access point for a first wireless local area network;
cause the first mobile device to present an interface that receives user input for at least one of authenticating the first mobile device or authorizing the first mobile device to connect to the first wireless local area network;
connect the first mobile device to the first wireless local area network based on the user input received via the interface;
determine, subsequent to connecting the first mobile device to the first wireless local area network, that a second mobile device is within a communication range of a second access point for a second wireless local area network;
determine the first mobile device and the second mobile device are associated with a common user; and
connect the second mobile device to the second wireless local area network based on the first mobile device and the second mobile device are associated with a common user.

16. The non-transitory computer-readable medium of claim 15, wherein the instructions are further for causing the processing device to determine a first service set identifier for the first access point and a second service set identifier for the second access point are governed by a common access policy, wherein the instructions for causing the processing device to connect the second mobile device to the second wireless local area network further comprises instructions for causing the processing device to connect the second mobile device to the second wireless local area network based on the first service set identifier and the second service set identifier being governed by the common access policy.

17. The non-transitory computer-readable medium of claim 16, further comprising a third access point for a third wireless local area network, the third access point having a third service set identifier, wherein the instructions are further for causing the processing device to:
determine, subsequent to connecting the first mobile device to the first wireless local area network, that the second mobile device is within a communication range of the third access point;
determine that the third service set identifier for the third access point is governed by the common access policy;
identify an update to the common access policy that occurred subsequent to the first mobile device being connected to the first wireless local area network; and
cause, based on identifying the update, the second mobile device to present an additional interface for performing at least one of authenticating the second mobile device or authorizing the second mobile device to connect to the third wireless local area network.

18. The non-transitory computer-readable medium of claim 16, wherein the instructions are further for causing the processing device to:
match the second service set identifier to a product or service provider;
determine that the second mobile device is in a geographic location corresponding to the product or service provider based on a connection of the second mobile device to the second wireless local area network; and
cause, based on determining that the second mobile device is in the geographic location, the second mobile device to present promotional content for the product or service provider.

19. The non-transitory computer-readable medium of claim 15, wherein the instructions for causing the processing device to determine the first mobile device and the second mobile device are associated with the common user comprises instructions for causing the processing device to:
determine identity data associated with the common user based on the user input received via the interface;
access a list of mobile devices associated with the common user from the non-transitory computer-readable medium using the identity data associated with the common user; and
match identity data associated with the second mobile device with identity data included in the list of mobile devices associated with the common user.

20. The non-transitory computer-readable medium of claim 15, wherein the instructions are further for causing the processing device to determine, based on the first mobile device and the second mobile device being associated with the common user, that the interface should not be presented at the second mobile device when the second mobile device is within the communication range of the second access point.
